(19) United States
(12) Patent Application Publication
(10) Pub. No.: US 2021/0371672 A1
(43) Pub. Date: Dec. 2, 2021

(54) TWO-LAYERED DENSE METAL ANTICORROSIVE COATING FORMED BY LOW-TEMPERATURE SINTERING, PREPARATION METHOD THEREFOR, AND USE THEREOF

(71) Applicant: Zhejiang University, Hangzhou (CN)

(72) Inventors: Dongming Yan, Hangzhou (CN); Yi Liu, Hangzhou (CN); Zhihao Huang, Hangzhou (CN)

(21) Appl. No.: 17/054,773

(22) PCT Filed: May 12, 2019
(86) PCT No.: PCT/CN2019/086508

§ 371 Date: Nov. 12, 2020

(30) Foreign Application Priority Data
May 12, 2018 (CN) CN201810451921.8

(51) Int. Cl. C09D 5/08; C09D 1/00; C09D 7/61; C09D 7/63; C23C 24/08; C23C 28/00

(52) U.S. Cl. CPC C09D 5/08; C09D 1/00; C23C 28/345; C09D 7/63; C23C 24/085; C09D 7/61

(57) ABSTRACT

The invention discloses a two-layered dense metal anticorrosive coating formed by low temperature sintering with an outer layer of an inorganic ceramic coating and an inner layer of a base oxide coating. The raw materials comprise the following components by weight: 50-60 weight percent silicone compound, 20-35 weight percent thermal expansion coefficient adjuster, 3-7 weight percent binder, 5-10 weight percent adhesion adjuster, and 1-4 weight percent catalyst. A preparation process for the two-layered dense metal anticorrosive coating formed by low-temperature sintering comprises the following steps: 1) grinding, 2) wet mixing, 3) drying, 4) grinding, 5) coating, 6) sintering. The coating of this invention has high adhesion, outstanding anti-corrosion resistance, and good durability.

### CROSS REFERENCE TO RELATED APPLICATION

This application is a national stage application of International application number PCT/CN2019/086508, filed May 12, 2019, titled “TWO-LAYERED DENSE METAL ANTICORROSIVE COATING FORMED BY LOW-TEMPERATURE SINTERING, PREPARATION METHOD THEREFOR, AND USE THEREOF,” which claims the priority benefit of Chinese Patent Application No. 201810451921.8, filed on May 12, 2018, which is hereby incorporated by reference in its entirety.

### TECHNICAL FIELD

The present invention relates to metallic materials technology, particularly, to two-layered dense metal anticorrosive coating formed by low-temperature sintering preparation method therefor, and use thereof.

### BACKGROUND

The most common electrochemical corrosion of metals is that metals come into contacting with media in the surrounding environment and undergoing chemical reactions. Due to the contact between the metal surface and the surrounding medium (such as wet air, electrolyte solution, etc.), the metal anode dissolution and the corresponding cathode process would occur at the contact interface, forming a spontaneous corrosion battery, so that the metal anode dissolution continues, resulting in metal corrosion.

The survey shows that the annual economic loss caused by metal corrosion accounts for about 4% of the global GDP, far exceeding the sum of flood, fire, wind and earthquake losses. Corrosion not only causes economic losses, but also often poses a threat to safety. Many catastrophic corrosion accidents have occurred at home and abroad. In particular, it is worth noting that marine steel structure facilities such as ships and drilling platforms are eroded by various corrosive media in the marine environment all year round, resulting in different degrees of corrosion.

Adhesion is an important indicator for the coating, which is the ability of the coating to bond with the metal matrix. The greater adhesion, the tighter bond between the coating and the metal matrix, which means that the coating has better integrity and the best protection for the metal matrix. However, the adhesion of the existing inorganic anti-corrosion coating is generally 5 MPa, and there is no inorganic anti-corrosion coating with adhesion more than 12 MPa.

### DESCRIPTION OF THE INVENTION

To overcome the disadvantages and shortcomings of the prior art, the invention aims to provide a two-layered dense metal anti-corrosion coating formed by low-temperature sintering, in particular a metal anti-corrosion coating with an adhesion of more than 12 MPa, which is applicable to the metal anti-corrosion field under corrosive environment, such as saline alkali soil, underground pipeline, marine platform, etc.

The present invention is achieved through the following technical solutions:

The first object of the invention is to provide a two-layered dense metal anticorrosive coating formed by low-temperature sintering, which is characterized in that:

To solve the metal corrosion problems, this invention provides a two-layered dense metal anti-corrosion coating by low-temperature sintering composed of an inorganic ceramic coating and a base oxide coating.

In the two-layered coating, the inorganic ceramic coating is the outer layer and the base oxide coating is the inner layer. The composition of the outer inorganic ceramic coating includes by weight: 50-60 weight percent silicone compound, 20-35 weight percent thermal expansion coefficient adjuster, 3-7 weight percent binder, 5-10 weight percent adhesion adjuster, 1-4 weight percent catalyst.

The adhesion adjuster contains methyl orthosilicate (TMOS), ethyl orthosilicate (TEOS), sodium silicate, or a combination thereof.

The base oxide coating is automatically generated by the metal matrix and oxygen on the surface of the matrix metal after sintering. The composition of the base oxide coating is 100 weight percent matrix metal oxide. The compositions of base oxide contain the metal of matrix and oxygen.

The inner layer is in contact with the metal matrix, and the thickness ratio of the outer inorganic ceramic coating to the inner base oxide coating is (4-6):1.

Preferably, the silica oxide compound contains quartz sand, diatomaceous earth, quartz, scale quartz, cristobalite, and powder quartz, or a combination thereof.

Preferably, the silicon oxide compound is an ultrafine powder with a particle size of 1000-2000 mesh, preferably 1100-1400 mesh.

Preferably, the thermal expansion coefficient adjuster contains potassium tetraborate, sodium tetraborate, lithium tetraborate, rubidium tetraborate, zinc oxide, cadmium oxide and copper oxide, or a combination thereof.

Preferably, the binder contains manganese oxide, manganese dioxide, nickel oxide (NiO), nickel oxide (Ni₂O₃), cobalt oxide (CoO) and cobalt oxide (Co₂O₃), or a combination thereof.

Preferably, catalyst contains acid catalyst and alkaline catalyst, or a combination thereof.

Preferably, acid catalyst is selected from hydrochloric acid, acetic acid and oxalic acid, or a combination thereof.

Preferably, alkaline catalyst is selected from ammonia, sodium hydroxide and potassium hydroxide, or a combination thereof.

Preferably, the sintering temperature of coating preparation is 500-540° C.

Preferably, the metal matrix is steel, and the ultimate tensile strain of the two-layered dense metal anticorrosive coating is 1400-2200 micro-strains (με).

Preferably, the adhesion of the two-layered dense metal anticorrosive coating can reach 13-17 Mpa.

The second object of the invention is to provide a two-layered dense metal anticorrosive coating formed by low-temperature sintering and a metal product with the metal anticorrosive coating, which contains the following steps:

1) First grinding: according to a weight ratio described, 50-60 weight percent silicone compound, 20-35 weight percent thermal expansion coefficient adjuster, 3-7 weight percent binder are ground into powder.

2) Wet mixing: 5-10 weight percent adhesion adjuster, 1-4 weight percent catalyst and water are added to the mixture obtained in step 1), then thoroughly mixed to yield slurry.

3) Drying: the yield slurry obtained in step 2) is dried to obtain the mixture.

4) Second grinding: the mixture obtained in step 3) is ground into powder.

5) Coating: the powder obtained in step 4) is coated on the base metal.

6) Sintering: the coated metal obtained in step 5) is sintered. A two-layered dense metal anticorrosive coating is formed by low-temperature sintering, which includes an inorganic ceramic coating and a base oxide coating, as well as a metal product of a two-layered dense metal anticorrosive coating with an inorganic ceramic coating and a base oxide coating is formed by low-temperature sintering.

This invention provides a two-layered dense metal anti-corrosion coating by low-temperature sintering composed of an inorganic ceramic coating and a base oxide coating.

In the two-layered coating, the inorganic ceramic coating is the outer layer and the base oxide coating is the inner layer. The composition of the outer inorganic ceramic coating includes by weight: 50-60 weight percent silicone compound, 20-35 weight percent thermal expansion coefficient adjuster, 3-7 weight percent binder, 5-10 weight percent adhesion adjuster, 1-4 weight percent catalyst.

In this invention, adhesion adjusters undergo hydrolysis and polycondensation reactions with catalysts, and undergo complex physical changes and chemical reactions with silicone compounds, thermal expansion coefficient modifiers, and binders, thereby forming a two-layered dense metal anti-corrosion coating including the inorganic ceramic coating and the base oxide coating. Because of the existence of the two-layered structure and the thickness ratio of the inorganic ceramic coating and the base oxide coating is (4-6):1, the adhesion of the two-layered dense metal anticorrosive coating formed by the low-temperature sintering can reach 13-17 MPa in the present invention, therefore the corrosion resistance of the coating has been improved by more than 10 times, and it can be deformed in cooperation with the building reinforcement under high strain.

The adhesion adjuster contains methyl orthosilicate (TMOS), ethyl orthosilicate (TEOS), sodium silicate, or a combination thereof. The adhesion adjuster is catalyzed in two steps under the action of an acid catalyst and an alkaline catalyst. First, the adhesion adjuster is hydrolyzed to form a sol, and then the sol undergoes polycondensation to form a hydrogel with silicone functional groups. The hydrogel is adsorbed on the surface of the silicone compound before the coating is sintered. The silicone functional group is the nucleating material of the coating substrate. During the sintering process, the silicon-oxygen bond in the silicone compound is closely connected with to form a closed three-dimensional network which can reduce the sintering temperature of the coating, so that the sintering temperature is about 500-540° C. Silicon oxide gel also has an excellent thermal insulation function, which can ensure the uniformity of the coating temperature during the high-temperature sintering process, therefore the performance of the whole coated steel bar is uniform. In addition, the silicon elements in the silicon oxide gel and the silicon oxide compound from the raw material can diffuse and connect with each other, so that the silicon oxide gel can better serve as a binder and make the coating more uniform and denser to improve corrosion resistance. Various acidic catalysts and basic catalysts can promote the hydrolysis reaction and polycondensation reaction of the adhesion modifier, respectively. Meanwhile, the hydrolysis and polycondensation reactions are promoted, the formed silicon oxide gel can be more closely adsorbed on the surface of the silicon oxide compound, promoting the density and corrosion resistance of the coating.

The base oxide coating is automatically generated by the metal matrix and oxygen on the surface of the matrix metal after sintering. The composition of the base oxide coating is 100 weight percent matrix metal oxide. The compositions of base oxide contain the metal of matrix and oxygen, for example, when the metal matrix is iron plate, steel bar, steel bar, the metal matrix oxide is iron oxide; when the metal matrix is copper plate, the metal matrix oxide is copper oxide; When the metal matrix oxide is aluminum oxide.

The inner layer is in contact with the metal matrix, and the thickness ratio of the outer inorganic ceramic coating to the inner base oxide coating is (4-6):1.

Preferably, the coating on the metal matrix in the step 5) is obtained by the electrostatic spraying, in which the electrostatic voltage is 30-40 kV, the current is 20-25 μA, the air output is 5-8 liters per minute, and the spraying distance is 20-50 cm.

Preferably, the sintering parameters of step 6) are: the temperature is 500 to 540° C., the sintering time is 10 to 20 minutes, and the heating rate is 5 to 10° C. per minute.

Preferably, the silica oxide compound contains quartz sand, diatomaceous earth, quartz, scale quartz, cristobalite, and powder quartz, or a combination thereof. The surface of the silicon oxide compound would be tightly adsorbed by the catalyzed silicon oxide gel to form a three-dimensional network after reaction and sintering, which greatly improves the coating density and corrosion resistance.

Preferably, the silicon oxide compound is an ultrafine powder with a particle size of 1000-2000 mesh, preferably 1100-1400 mesh.

Preferably, the thermal expansion coefficient adjuster contains potassium tetraborate, sodium tetraborate, lithium tetraborate, rubidium tetraborate, zinc oxide, cadmium oxide, and copper oxide, or a combination thereof. Potassium tetraborate, sodium tetraborate, lithium tetraborate, rubidium tetraborate are soluble and alkaline in water. Potassium tetraborate, sodium tetraborate, lithium tetraborate, and rubidium tetraborate can increase the CTE (coefficient of thermal expansion) of the coating during sintering to avoid expansion cracking due to uneven stress. Zinc oxide, cadmium oxide, and copper oxide can reduce the CTE (coefficient of thermal expansion) of the coating during sintering to avoid shrinkage and cracking caused by the coating cooling. The combination of the different thermal expansion coefficient adjusters can ensure the integrity of the coating during heating or cooling.

Preferably, the binder contains manganese oxide, manganese dioxide, nickel oxide (NiO), nickel oxide (Ni₂O₃), cobalt oxide (CoO) and cobalt oxide (Co₂O₃), or a combination thereof. For example, manganese oxide is selected as the binder, the oxygen element in manganese oxide is linked to the silicon element in the coating to form a silicon-oxygen bond, and the manganese element is linked to the oxide layer on the metal surface to form a manganese-oxygen bond, when the coating is sintered at a high temperature. In this way, a strong chemical bond is formed between the coating and the reinforcement, which can ensure a tight bond between the coating and the reinforcement.

Preferably, catalyst contains acid catalyst and alkaline catalyst, or a combination thereof. A variety of acidic catalysts and basic catalysts can promote the hydrolysis and polycondensation reactions of silicon aerogel precursors, respectively. Simultaneously, promoting hydrolysis and polycondensation can make the formed silicon aerogel more closely adsorbed on the surface of the silicon oxide compound, and promote the density and corrosion resistance of the coating.

Preferably, acid catalyst is selected from hydrochloric acid, acetic acid and oxalic acid, or a combination thereof.

Preferably, alkaline catalyst is selected from ammonia, sodium hydroxide and potassium hydroxide, or a combination thereof.

The third object of the present invention is to provide a metal product comprising a two-layered dense metal anticorrosive coating formed by any form of low temperature sintering as described above.

Preferably, the metal matrix of the metal product contains iron plates, steel plates, steel bars, copper plates, and aluminum plates.

The fourth object of the present invention is to provide the use of a two-layered dense metal anticorrosive coating and the metal product formed by any form of low-temperature sintering as described above, which can be applied in civil construction, pipelines, underground pipe corridors, marine oil production platform, saline-alkali infrastructure, new energy power generation and other fields.

The invention has the following advantages and positive effects: 1) Silicone compound, thermal expansion coefficient adjuster, binder, adhesion adjuster, catalyst are added to make the coating of the present invention have a two-layered structure with an outer layer of inorganic ceramic coating and an inner layer of base oxide coating. The thickness ratio of the inorganic ceramic coating and the base oxide coating is (4-6):1. As a result, the adhesion of the coating has been significantly improved, reaching 13-17 Mpa, which is 2-4 times that of the general coating. 2) Because the adhesion is improved, the corrosion resistance of the coating is improved. The coating of the present invention can improve the corrosion resistance of the steel bar by more than 10 times in the simulated seawater immersion environment. 3) Because of the improvement of adhesion, the ductility of the coating is improved. When the coating IS applied to steel bars, the ultimate tensile strain of the coating of the present invention is in the range of 1400-2200 micro-strains (με), which can be deformed cooperatively with the building steel bars.

### BRIEF DESCRIPTION OF THE DRAWINGS

FIG. 1 shows a SEM image of an anti-corrosion coating, according to embodiment 1 of the invention (the scale is 200 μm).

### DETAILED DESCRIPTION OF THE PREFERRED EMBODIMENTS

Other embodiments of the present invention will be easily understood by those skilled in the art from the following detailed description, in which the embodiments of the present invention are described by illustrating the best mode contemplated for carrying out the present invention. As will be realized, the invention is capable of other and different embodiments, and its several details are capable of modification in various obvious respects, all without departing from the spirit and scope of the invention. Therefore, the drawings and detailed description should be regarded as illustrative rather than restrictive in nature. It should be noted that various changes and modifications practiced or adopted by those skilled in the art without creative work should be understood to be included within the scope of the present invention as defined by the appended claims.

### Embodiment 1

A two-layered dense metal anti-corrosion coating is fabricated by low-temperature sintering, in which the component includes: 60 weight percent quartz sand, 24 weight percent potassium tetraborate, 3 weight percent zinc oxide, 7 weight percent nickel oxide (NiO), 5 weight percent ethyl orthosilicate (TEOS), 1 weight percent hydrochloric acid.

1) First grinding: according to a weight ratio described, 60 weight percent quartz sand, 24 weight percent potassium tetraborate, 3 weight percent zinc oxide, 7 weight percent nickel oxide (NiO) are mixed and ground into powder.

2) Wet mixing: 5 weight percent ethyl orthosilicate (TEOS), 1 weight percent hydrochloric acid and water are added to the mixture obtained in step 1), then thoroughly mixed to yield slurry.

3) Drying: the yield slurry obtained in step 2) is dried to obtain the mixture.

4) Second grinding: the mixture obtained in step 3) is ground into powder.

5) Coating: the powder obtained in step 4) is coated on the base metal by the electrostatic spraying, in which the electrostatic voltage is 35 kV, the current is 23 μA, the air output is 6 liters per minute, and the spraying distance is 30 cm.

6) Sintering: the coated metal obtained in step 5) is sintered at 520° C. for 15 minutes with the heating rate of 7.5° C. per minute. A two-layered dense metal anticorrosive coating is formed by low-temperature sintering, which includes an inorganic ceramic coating and a base oxide coating, as well as a metal product of a two-layered dense metal anticorrosive coating with an inorganic ceramic coating and a base oxide coating is formed by low-temperature sintering.

The specific steps of embodiments 1-3 and comparison embodiments 1-3 are as in embodiment 1, and the specific ratio (weight ratio) is shown in Table 1.

TABLE 1
Specific composition ratio (weight ratio) and production process parameter
settings of embodiments 1-3 and comparative embodiments 1-3.

| | | | | | Comparative | Comparative | Comparative |
|---|---|---|---|---|---|---|---|
| | | Embodiment | Embodiment | Embodiment | embodiment | embodiment | embodiment |
| | | 1 | 2 | 3 | 1 | 2 | 3 |
| Silicone | Quartz sand | 25 | | 10 | 25 | | 25 |
| compound | Diatomaceous | 10 | | 10 | | | 10 |
| | earth | | | | | | |
| | Quartz | 10 | 20 | | | 20 | 10 |
| | Scale quartz | 15 | 20 | | 20 | 20 | 15 |
| | Cristobalite | | 10 | 10 | | 10 | |
| | Powder | | 5 | 20 | | 5 | |
| | quartz | | | | | | |
| Thermal | Lithium | 10 | | 10 | | | 10 |
| expansion | tetraborate | | | | | | |
| coefficient | Rubidium | 10 | 10 | | 30 | 10 | 10 |
| adjuster | tetraborate | | | | | | |
| | Sodium | 4 | 10 | 5 | | 10 | 4 |
| | tetraborate | | | | | | |
| | Potassium | | 11 | 2 | | 11 | |
| | tetraborate | | | | | | |
| | Zinc oxide | 1 | | | 10 | | 1 |
| | Cadmium | 1 | 2 | 3 | | 2 | 1 |
| | oxide | | | | | | |
| | Copper | 1 | 2 | | | 2 | 1 |
| | oxide | | | | | | |
| Binder | Manganese | 3 | 1 | | | 1 | 3 |
| | oxide | | | | | | |
| | Manganese | 2 | | 3 | | | 2 |
| | dioxide | | | | | | |
| | Nickel | 2 | | 2 | 2 | | 2 |
| | oxide (NiO) | | | | | | |
| | Nickel | | 1 | | | 1 | |
| | oxide | | | | | | |
| | (Ni₂O₃) | | | | | | |
| | Cobalt | | | 2 | | | |
| | oxide (CoO) | | | | | | |
| | cobalt oxide | | 1 | | | 1 | |
| | (Co₂O₃) | | | | | | |
| Adhesion | Methyl | 5 | | 2 | 11 | | |
| adjuster | orthosilicate | | | | | | |
| | (TMOS) | | | | | | |
| | Ethyl | | 4 | 4 | | 4 | |
| | orthosilicate | | | | | | |
| | (TEOS) | | | | | | |
| | Sodium | | 1 | | | 1 | |
| | silicate | | | | | | |
| | Water glass | | | 4 | | | |
| | Silicic acid | | | | | | 5 |
| Catalyst | Hydrochloric | 1 | | | 1 | | 1 |
| | acid | | | | | | |
| | Acetic acid | | | 2 | | | |
| | Oxalic acid | | | 1 | 1 | | |
| | Ammonia | | 1 | | | 1 | |
| | Sodium | | 0.5 | | | 0.5 | |
| | hydroxide | | | | | | |
| | Potassium | | 0.5 | | | 0.5 | |
| | hydroxide | | | | | | |
| Matrix | | Steel | Steel | Steel | Steel | Steel | Steel |
| metal | | bar/plate | bar/plate | bar/plate | bar/plate | bar/plate | bar/plate |
| Preparation | Voltage | 35 | 40 | 30 | 35 | 20 | 35 |
| process | (kV) | | | | | | |
| | Current | 23 | 20 | 25 | 23 | 10 | 23 |
| | (uA) | | | | | | |
| | Air output | 6 | 5 | 8 | 6 | 12 | 6 |
| | (L/min) | | | | | | |
| | Spraying | 30 | 50 | 20 | 30 | 10 | 30 |
| | distance | | | | | | |
| | (cm) | | | | | | |
| | Sintering | 520 | 540 | 500 | 520 | 580 | 520 |
| | temperature | | | | | | |
| | (° C.) | | | | | | |
| | Sintering | 15 | 20 | 10 | 15 | 15 | 15 |
| | time (min) | | | | | | |
| | Sintering | 7.5 | 10 | 5 | 7.5 | 12 | 7.5 |
| | temperature | | | | | | |
| | increase rate | | | | | | |
| | (° C./min) | | | | | | |
| thickness | Inorganic | 4.5:1 | 4:1 | 6:1 | — | — | — |
| ratio | ceramic | | | | | | |
| | coating:base | | | | | | |
| | oxide | | | | | | |
| | coating | | | | | | |
| composition of | | FeO | FeO | FeO | No base | No base | No base |
| the base oxide | | Fe₂O₃ | Fe₂O₃ | Fe₂O₃ | oxide | oxide | oxide |
| | | Fe₃O₄ | Fe₃O₄ | Fe₃O₄ | coating | coating | coating |

To verify the thickness ratio of inner and outer coating and composition of base oxide coating, steel rebars of embodiments 1-3 are conducted and analyzed by SEM measurement.

From Table 1, the two-layered dense metal anticorrosive coating of the invention can be prepared only when the material ratio of the specific material silicon oxide compound, the thermal expansion coefficient regulator, the binder, the adhesion regulator, the catalyst and the corresponding preparation process parameters are met, and the thickness ratio of the inorganic ceramic coating and the base oxide coating meets (4-6):1.

To verify the effect of the coating and coating method for reinforcing steel corrosion protection of the invention, the related tests are conducted and analyzed.

1) Adhesion test: six groups of steel plates of embodiments 1-3 and comparative embodiments 1-3 were selected, each group of 3 repeated samples. According to the requirements of GB/T 5210-2006 test for adhesion of paints and varnishes by pull off, the adhesion tester is used to test the adhesion and read the values on the instrument.

TABLE 2
The adhesion test of coated steel plates.

| | Adhesion (Mpa) | | | |
|---|---|---|---|---|
| | Coated steel | Coated steel | Coated steel | |
| Group | plate 1 | plate 2 | plate 3 | Average |
| Embodiment 1 | 16.5 | 16.8 | 16.4 | 16.6 |
| Embodiment 2 | 15.0 | 14.8 | 15.2 | 15.0 |
| Embodiment 3 | 13.4 | 13.2 | 13.3 | 13.3 |
| Comparison | 4.9 | 5.2 | 6.0 | 5.4 |
| embodiment 1 | | | | |
| Comparison | 5.1 | 4.8 | 4.7 | 4.9 |
| embodiment 2 | | | | |
| Comparison | 6.0 | 6.2 | 5.8 | 6.0 |
| embodiment 3 | | | | |

From Table 2, the adhesion range of embodiment 1-3 is 13-17 MPa, it can be seen that it is significantly better than the general organic coating, and the adhesion range of comparative embodiment 1-3 is about 5-6 MPa, only one third of embodiments 1-3.

2) Tension test: six groups of the embodiments 1-3 and comparison embodiment 1-3 were done, each group of 3 repeated samples, and each steel rebar was attached with three electric resistance strain gauges. At the beginning of the test, the steel bar was placed on a tensile testing machine to measure the change of strain with load, and the resistance strain gauge was connected to a strain gauge to measure the strain change on the coated steel bar.

TABLE 3
Tension test of steel rebars.

| | | Strain value of coating cracking (με) | | | |
|---|---|---|---|---|---|
| | | Point 1 | Point 2 | Point 3 | Average |
| Embodiment 1 | Rebar No. 1 | 1609 | 1602 | 1605 | 1605 |
| | Rebar No. 2 | 1623 | 1559 | 1576 | 1586 |
| | Rebar No. 3 | 1581 | 1549 | 1523 | 1551 |
| Embodiment 2 | Rebar No. 1 | 1805 | 1805 | 1794 | 1858 |
| | Rebar No. 2 | 1708 | 1698 | 1756 | 1720 |
| | Rebar No. 3 | 1781 | 1823 | 1801 | 1801 |
| Embodiment 3 | Rebar No. 1 | 1899 | 1889 | 1924 | 1904 |
| | Rebar No. 2 | 1892 | 1922 | 1853 | 1889 |
| | Rebar No. 3 | 1980 | 1938 | 1923 | 1947 |
| Comparison | Rebar No. 1 | 901 | 932 | 998 | 945 |
| embodiment 1 | Rebar No. 2 | 924 | 953 | 951 | 943 |
| | Rebar No. 3 | 923 | 981 | 892 | 932 |
| Comparison | Rebar No. 1 | 803 | 807 | 805 | 805 |
| embodiment 2 | Rebar No. 2 | 768 | 787 | 792 | 782 |
| | Rebar No. 3 | 797 | 762 | 800 | 786 |
| Comparison | Rebar No. 1 | 1022 | 1033 | 1024 | 1026 |
| embodiment 3 | Rebar No. 2 | 1045 | 1026 | 1035 | 1035 |
| | Rebar No. 3 | 1036 | 1038 | 1040 | 1038 |

From Table 3, the average strain range of the coated steel bars in embodiments 1-3 are 1600-1900με. The average strain range of the coated reinforcement in the comparison embodiments 1-3 are 750-1000με, so the coating in the embodiments 1-3 can be stretched with the building reinforcement, while the coating in the comparison embodiments 1-3 cannot be deformed with the building reinforcement. Therefore the ductility of the embodiments 1-3 are very high compared with the comparison embodiments 1-3.

3) Corrosion resistance test of steel bars: six groups of coated steel bars of embodiment 1-3 and comparison embodiments 1-3 were selected respectively. The control group was uncoated steel bars, and the total number of experimental steel bars was 21. Put them in 3.5 wt. % sodium chloride solution and conduct accelerated corrosion test after energizing.

TABLE 4
Accelerated corrosion test of steel bars

| | Corrosion time (min) | | | |
|---|---|---|---|---|
| Group | Steel bar 1 | Steel bar 2 | Steel bar 3 | Average |
| Embodiment 1 | 1020 | 1080 | 1004 | 1035 |
| Embodiment 2 | 1085 | 1099 | 1105 | 1096 |
| Embodiment 3 | 1123 | 1145 | 1099 | 1122 |
| Comparison | 596 | 513 | 592 | 567 |
| embodiment 1 | | | | |
| Comparison | 588 | 560 | 540 | 563 |
| embodiment 2 | | | | |
| Comparison | 700 | 680 | 690 | 690 |
| embodiment 3 | | | | |
| Control group | 113 | 123 | 112 | 116 |

From Table 4, the corrosion time for the coated steel bars of embodiments 1, 2 and 3 to remain uncorroded is 9-10 times of that of uncoated steel bars, and the corrosion time for the coated steel bars of comparison embodiments 1, 2 and 3 to remain uncorroded is 5 times of that of uncoated steel bars, but only half of that of the coated steel bars of embodiments 1, 2 and 3.

4) Corrosion resistance test of steel plates: six groups of coated steel plates of embodiment 1-3 and comparison embodiments 1-3 were selected respectively. The control group was uncoated steel plates, and the total number of experimental steel plates was 21. Put them in 3.5 wt. % sodium chloride solution and conduct accelerated corrosion test after energizing.

TABLE 5
Accelerated corrosion test of steel plates

| | Corrosion time (min) | | | |
|---|---|---|---|---|
| Group | Steel plate 1 | Steel plate 2 | Steel plate 3 | Average |
| Embodiment 1 | 1120 | 1167 | 1103 | 1130 |
| Embodiment 2 | 1121 | 1099 | 1201 | 1140 |
| Embodiment 3 | 1279 | 1257 | 1283 | 1273 |
| Comparison | 723 | 684 | 672 | 693 |
| embodiment 1 | | | | |
| Comparison | 678 | 666 | 650 | 664 |
| embodiment 2 | | | | |
| Comparison | 756 | 742 | 735 | 744 |
| embodiment 3 | | | | |
| Control group | 113 | 123 | 112 | 116 |

From Table 5, the corrosion time for the coated steel plates of embodiments 1, 2 and 3 to remain uncorroded is 10-11 times of that of uncoated steel plates, and the corrosion time for the coated steel plates of comparison embodiments 1, 2 and 3 to remain uncorroded is 6 times of that of uncoated steel plates, but only half of that of the coated steel plates of embodiments 1, 2 and 3.

5) Electron micrograph of coating cross section

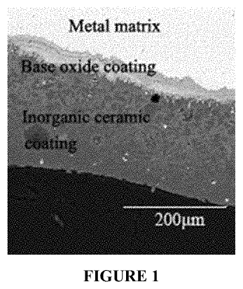

The electron microscope image of embodiment 1 is shown in FIG. 1, which is similar to that of embodiments 2 and 3. It can be seen that the coating is very dense, with only a few closed cells. Meanwhile, it can also be found that the coating has a two-layered structure, which is composed of a base oxide coating and an inorganic ceramic coating. The base oxide coating makes the bond between the coating and the metal matrix tighter, which can effectively improve the corrosion resistance of the coating. The thickness of the base oxide coating is 35.6 μm, the thickness of the inorganic ceramic coating is 160.5 μm, and the thickness ratio of the inorganic ceramic coating to the base oxide coating is 4.5:1.

What is claimed is:

1. A two-layered dense metal anticorrosive coating formed by low temperature sintering, characterized by:
a dense metal anticorrosive coating formed by low temperature sintering is a two-layered structure coating, which is composed of an inorganic ceramic coating and a base oxide coating; in the two-layered coating, the inorganic ceramic coating is the outer layer and the base oxide coating is the inner layer; the composition of the inorganic ceramic coating includes by weight: 50-60 weight percent silicone compound, 20-35 weight percent thermal expansion coefficient adjuster, 3-7 weight percent binder, 5-10 weight percent adhesion adjuster, 1-4 weight percent catalyst;
the adhesion adjuster contains methyl orthosilicate (TMOS), ethyl orthosilicate (TEOS), sodium silicate, or a combination thereof;
the base oxide coating is automatically generated by the metal matrix and oxygen on the surface of the matrix metal after sintering; the composition of the base oxide coating is 100 weight percent matrix metal oxide; the compositions of base oxide contain the metal of matrix and oxygen;
the inner layer is in contact with the metal matrix, and the thickness ratio of the outer inorganic ceramic coating to the inner base oxide coating is (4-6):1.

2. The two-layered dense metal anticorrosive coating formed by low temperature sintering of claim 1, wherein the silica compound comprises quartz sand, diatomite, quartz, tridymite, cristobalite and silty quartz, or a combination thereof.

3. The two-layered dense metal anticorrosive coating formed by low temperature sintering of claim 2, wherein the silica compound is ultrafine powder with particle size of 1000-2000 mesh.

4. The two-layered dense metal anticorrosive coating formed by low temperature sintering of claim 1, wherein the thermal expansion coefficient adjuster contains potassium tetraborate, sodium tetraborate, lithium tetraborate, rubidium tetraborate, zinc oxide, cadmium oxide and copper oxide, or a combination thereof.

5. The two-layered dense metal anticorrosive coating formed by low temperature sintering of claim 1, wherein the binder contains manganese oxide, manganese dioxide, nickel oxide (NiO), nickel oxide (Ni₂O₃), cobalt oxide (CoO) and cobalt oxide (Co₂O₃), or a combination thereof.

6. The two-layered dense metal anticorrosive coating formed by low temperature sintering of claim 1, wherein catalyst contains acid catalyst and alkaline catalyst, or a combination thereof.

7. The two-layered dense metal anticorrosive coating formed by low temperature sintering of claim 6, wherein acid catalyst is selected from hydrochloric acid, acetic acid and oxalic acid, or a combination thereof.

8. The two-layered dense metal anticorrosive coating formed by low temperature sintering of claim 6, wherein alkaline catalyst is selected from ammonia, sodium hydroxide and potassium hydroxide, or a combination thereof.

9. The two-layered dense metal anticorrosive coating formed by low temperature sintering according to claim 1, wherein the sintering temperature of coating preparation is 500-540° C.

10-11. (canceled)

12. A two-layered dense metal anticorrosive coating formed by low-temperature sintering and a metal product with the metal anticorrosive coating, which contains the following steps:
1) first grinding: according to a weight ratio described, 50-60 weight percent silicone compound, 20-35 weight percent thermal expansion coefficient adjuster, 3-7 weight percent binder are ground into powder;
2) wet mixing: 5-10 weight percent adhesion adjuster, 1-4 weight percent catalyst and water are added to the mixture obtained in step 1), then thoroughly mixed to yield slurry;
3) drying: the yield slurry obtained in step 2) is dried to obtain the mixture;
4) second grinding: the mixture obtained in step 3) is ground into powder;
5) coating: the powder obtained in step 4) is coated on the base metal; and
6) sintering: the coated metal obtained in step 5) is sintered; a two-layered dense metal anticorrosive coating is formed by low-temperature sintering, which includes an inorganic ceramic coating and a base oxide coating, as well as a metal product of a two-layered dense metal anticorrosive coating with an inorganic ceramic coating and a base oxide coating is formed by low-temperature sintering.

11. The preparation method according to claim 12, wherein the coating method in step 5) can use an electrostatic spray method, wherein the electrostatic voltage is 30-40 kV, the current is 20-25 μA, the air output is 5-8 liters per minute, the spraying distance is 20-50 cm.

14. The preparation method according to claim 13, the sintering parameters of step 6) are: the temperature is 500 to 540° C., the sintering time is 10 to 20 minutes, and the heating rate is 5 to 10° C. per minute.

15. The preparation method according to claim 12, wherein the silica oxide compound contains quartz sand, diatomaceous earth, quartz, scale quartz, cristobalite, and powder quartz, or a combination thereof.

16. The preparation method according to claim 12, wherein the silicon oxide compound is an ultrafine powder with a particle size of 1000-2000 mesh.

17. The preparation method according to claim 12, wherein the thermal expansion coefficient adjuster contains potassium tetraborate, sodium tetraborate, lithium tetraborate, rubidium tetraborate, zinc oxide, cadmium oxide, and copper oxide, or a combination thereof.

18. The preparation method according to claim 12, wherein the binder contains manganese oxide, manganese dioxide, nickel oxide (NiO), nickel oxide (Ni₂O₃), cobalt oxide (CoO) and cobalt oxide (Co₂O₃), or a combination thereof.

19. The preparation method according to claim 12, wherein catalyst contains acid catalyst and alkaline catalyst, or a combination thereof.

20. The preparation method according to claim 19, wherein acid catalyst is selected from hydrochloric acid, acetic acid and oxalic acid, or a combination thereof.

21. The preparation method according to claim 19, wherein alkaline catalyst is selected from ammonia, sodium hydroxide and potassium hydroxide, or a combination thereof.

22. A metal product, characterized in that the metal product comprises the two-layered dense metal anticorrosive coating formed by low temperature sintering according to claim 1.

23-24. (canceled)
